(19) United States
(12) Patent Application Publication
(10) Pub. No.: US 2025/0282439 A1
(43) Pub. Date: Sep. 11, 2025

(54) ELECTRIC VEHICLE FRAME FOR MOUNTING HIGH-CAPACITY BATTERY

(71) Applicant: Honda Motor Co., Ltd., Tokyo (JP)

(72) Inventors: BENJAMIN D. MONINGER, MARYSVILLE, OH (US); SETH A. RITCHIE, MARYSVILLE, OH (US); MICHAEL JOSEPH KLUCHAR, PLAIN CITY, OH (US)

(21) Appl. No.: 18/596,411

(22) Filed: Mar. 5, 2024

(51) Int. Cl. B62J 43/28; B62J 1/08; B62J 43/16; B62K 5/01

(52) U.S. Cl. CPC B62J 43/28; B62J 1/08; B62J 43/16; B62K 5/01

(57) ABSTRACT

A vehicle frame for a vehicle is provided for mounting a high-capacity battery. The vehicle frame includes a lower mount structure coupled to a lower portion of the vehicle frame. The vehicle frame further includes an upper mount structure coupled to an upper portion of the vehicle frame. The lower mount structure and the upper mount structure are configured to receive a battery unit in a space formed between the lower mount structure and the upper mount structure, such that the battery unit is slidably disposed in an inclined position in the space.

### BACKGROUND

A development of safe battery mounting techniques is required when integrating electric vehicle (EV) technology into powersports like all-terrain vehicles (ATVs). Because of their size, batteries need to be positioned differently than gasoline fuel and take up more space. This necessitates a mounting solution that integrates multiple vehicle functions that can hold a large battery. The structure also needs to be strong enough to endure the rigors of off-road driving.

Limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an embodiment of the disclosure, a vehicle frame for a vehicle may be provided to mount a high-capacity battery. The vehicle frame may include a lower mount structure that may be coupled to a lower portion of the vehicle frame. The vehicle frame may further include an upper mount structure that may be coupled to an upper portion of the vehicle frame. Further, the lower mount structure and the upper mount structure may be configured to receive a battery unit in a space that may be formed between the lower mount structure and the upper mount structure such that the battery unit may be slidably disposed in an inclined position in the space.

According to another embodiment of the disclosure, a battery mounting structure for a vehicle may be provided to mount a high-capacity battery. The battery mounting structure may include a lower mount structure that may be coupled to a lower portion of the vehicle frame. The battery mounting structure may further include an upper mount structure that may be coupled to an upper portion of the vehicle frame. Further, the lower mount structure and the upper mount structure may be configured to receive a battery unit in a space that may be formed between the lower mount structure and the upper mount structure such that the battery unit may be slidably disposed in an inclined position in the space.

According to another embodiment of the disclosure, a method of assembling a vehicle frame for a vehicle may be provided to mount a high-capacity battery. The method may include coupling a lower mount structure to a lower portion of a vehicle frame and coupling an upper mount structure to an upper portion of the vehicle frame. Further, the lower mount structure and the upper mount structure may be configured to receive a battery unit in a space that may be formed between the lower mount structure and the upper mount structure such that the battery unit may be slidably disposed in an inclined position in the space.

### BRIEF DESCRIPTION OF THE DRAWINGS

FIG. 1 is a diagram that illustrates an exemplary vehicle frame for a vehicle, in accordance with an embodiment of the disclosure.

FIG. 2A is a diagram that illustrates a lower mount structure associated with a battery mounting structure for a vehicle, in accordance with an embodiment of the disclosure.

FIG. 2B is a diagram that illustrates an upper mount structure associated with a battery mounting structure for a vehicle, in accordance with an embodiment of the disclosure.

FIG. 3 is a diagram that illustrates a shock absorber associated with a battery mounting structure for a vehicle, in accordance with an embodiment of the disclosure.

FIGS. 4A and 4B are scenario diagrams that collectively illustrate configuration of an upper mount structure in a stowed and an un-stowed configuration to control access to a battery unit associated with a vehicle, in accordance with an embodiment of the disclosure.

FIG. 5 is a flowchart that illustrates an exemplary method of assembling a vehicle frame for a vehicle, in accordance with an embodiment of the disclosure.

The foregoing summary, as well as the following detailed description of the present disclosure, is better understood when read in conjunction with the appended drawings. To illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a vehicle frame for a vehicle. The disclosed vehicle frame may include a lower mount structure that may be coupled to a lower portion of the vehicle frame. The vehicle frame may further include an upper mount structure that may be coupled to an upper portion of the vehicle frame. Further, the lower mount structure and the upper mount structure may be configured to receive a battery unit in a space that may be formed between the lower mount structure and the upper mount structure, such that the battery unit is slidably disposed in an inclined position in the space. The lower mount structure may be configured to support a bottom portion of the battery unit and the upper mount structure may be configured to secure a top portion of the battery unit. The lower mount structure may be coupled to the lower portion of the vehicle frame in the inclined position with respect to a horizontal plane. The inclination of the lower mount structure with respect to the horizontal plane may allow the battery unit to be securely placed in the inclined position.

The installation of a larger battery pack in off-road electric vehicles, such as electric all-terrain vehicles (ATVs) can cause a number of issues. For example, increased vehicle weight due to a larger battery pack can reduce efficiency, resulting in slower acceleration and poorer handling. Second, the location of the battery pack can affect the vehicle's center of gravity, which can impact drivability. Third, due to the risk of fire and explosion, the battery pack should not be deformed in any way. Finally, larger batteries necessitate more substantial structures/systems, and other components such as brakes, suspension, thermal management, and so on must be designed and reinforced to handle these issues, which add mass and cost to the vehicle.

To overcome some of the abovementioned issues, the proposed vehicle frame includes a two-part mount structure that is securely placed inside the vehicle frame in an inclined position. The space formed in the two-part mount structure is provided to slidably receive a battery unit (e.g., a larger battery pack that is suitable for electric vehicles), without requiring a disassembly of the vehicle frame or the two-part mount structure. The inclination helps to distribute the weight of the battery unit and eases removal or replacement of the battery unit from the vehicle frame. The structure includes rubber pads at the base portion to absorb the shocks and/or jerks experienced by the vehicle frame and protect the battery unit from any damage caused by the shocks and/or the jerks. A pivot point in the two-part mount structure facilitates access to the battery unit, which is otherwise secured in the space between the two-part mount structure.

Reference will now be made in detail to specific aspects or features, examples of which are illustrated in the accompanying drawings. Wherever possible, corresponding, or similar reference numbers will be used throughout the drawings to refer to the same or corresponding parts.

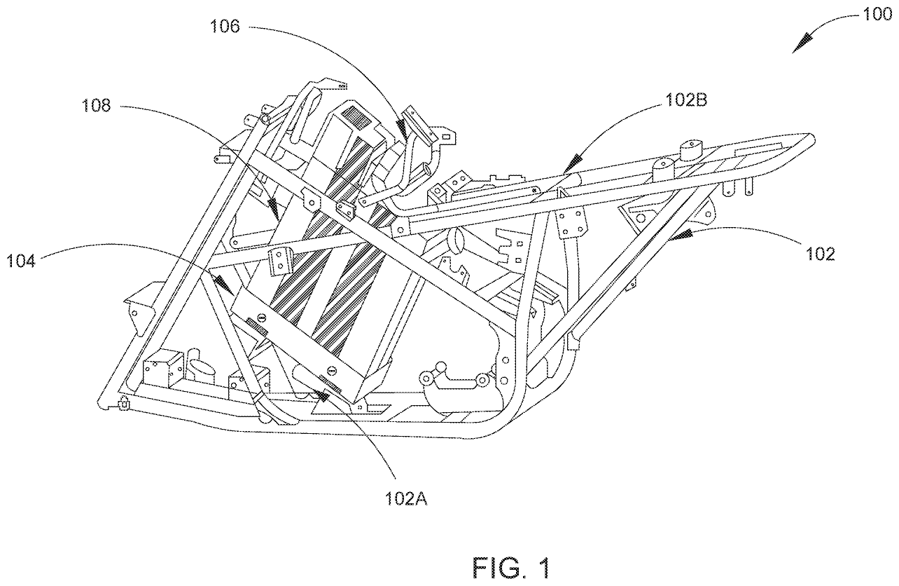

FIG. 1 is a diagram that illustrates an exemplary vehicle frame for a vehicle, in accordance with an embodiment of the disclosure. With reference to the FIG. 1, there is shown a diagram that includes an environment 100. The environment 100 may include a vehicle frame 102 which includes a lower portion 102A and an upper portion 102B. The environment 100 may further include a lower mount structure 104 associated with the lower portion 102A of the vehicle frame 102, and an upper mount structure 106 associated with the upper portion 102B of the vehicle frame 102. The vehicle frame 102 may further include a battery unit 108 accommodated between the lower mount structure 104 and the upper mount structure 106.

The vehicle may be an electric vehicle (EV) or a hybrid vehicle that uses one or more electric motors for propulsion. The vehicle can be powered by a collector system, with electricity from extravehicular sources, or the vehicle can be powered autonomously by a battery, which can be charged by solar panels, or by converting fuel to electricity using fuel cells or a generator. Examples of the vehicle may include, but are not limited to, a three-wheeled vehicle, a four-wheeled vehicle, a hybrid vehicle, or an off-road vehicle (such as an all-terrain vehicle). It should be noted here that the vehicle frame 102 shown in FIG. 1 is associated with an all-terrain vehicle, which uses a battery for propulsion merely as an example. The examples of the all-terrain vehicle may include, but is not limited to, a quad bike or a quad. The vehicle frame 102 may be also applicable to other types of battery electric vehicles, as defined by American National Standard Institute (ANSI). The description of such types of the vehicle has been omitted from the disclosure for the sake of brevity. The vehicle may include a battery mounting structure that may further include the vehicle frame 102.

The vehicle frame 102 of the vehicle may be a main support structure of the vehicle which may be configured to bear stresses induced on the vehicle. The vehicle frame 102 may be a load-bearing framework that may structurally support a plurality of vehicle systems, such as, but not limited to, a transmission system, a brake system, a suspension system, or a steering system. For example, the vehicle frame 102 for a quad bike may include components, such as, but not limited, a fuel tank, seat(s), handlebars, two wheels, or a suspension system. The present disclosure may be applicable to the vehicle frame 102 of other types of the all-terrain vehicles (for example, a quad having four wheels). The description of such types of vehicle frame 102 has been omitted from the disclosure for the sake of brevity. The vehicle frame 102 may include a lower portion 102A, and an upper portion 102B. By way of example, and not limitation, the lower portion 102A may be in proximity of a ground surface and the upper portion 102B may be away from the ground surface.

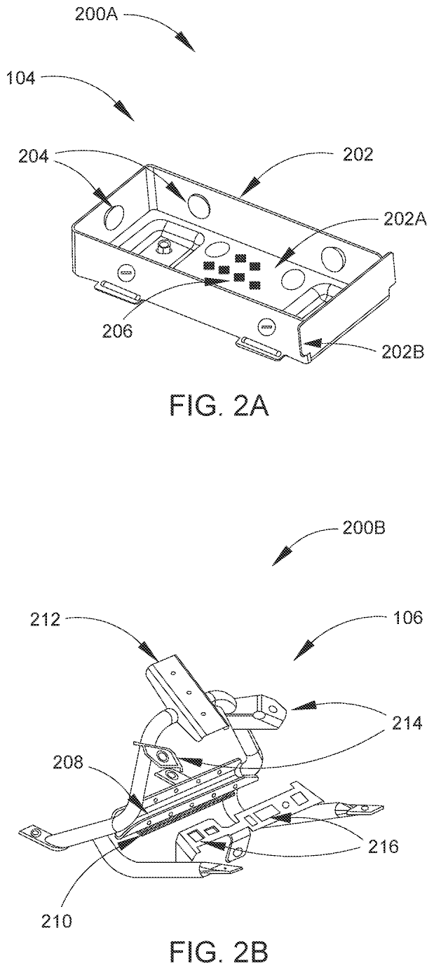

The lower mount structure 104 is shown to have a substantially rectangular shape in FIG. 1. Alternatively, the lower mount structure 104 may be formed to have another shape (for example, a substantially square shape, a substantially circular shape, a substantially semi-circular shape, and the like), without a departure from the scope of the present disclosure. A perspective view of the lower mount structure 104 is shown, for example in FIG. 2A. The lower mount structure 104 may be coupled to the lower portion 102A of the vehicle frame 102 and may be configured to receive a bottom portion of the battery unit 108. In an embodiment, the lower mount structure 104 may be made from high strength and shock absorbent materials (for example, a Polypropylene, a Polyurethane, a Polycarbonate, a Polyamide-imide, and the like) to bear stresses induced on the vehicle frame 102.

The upper mount structure 106 is shown to have a substantially tubular structure in FIG. 1. Alternatively, the lower mount structure 104 may be formed with other cross sections (for example, a substantially square shape, a substantially circular shape, a substantially semi-circular shape, and the like). The upper mount structure 106 may be coupled to the upper portion 102B of the vehicle frame 102 and may be configured to secure a top portion of the battery unit 108. In an embodiment, the upper mount structure 106 may be made from high strength and shock absorbent materials (for example, a Polypropylene, a Polyurethane, a Polycarbonate, a Polyamideimide, and the like) to bear stresses induced on the vehicle frame 102.

The battery unit 108 may be a rechargeable battery, that is, a source of electric power for one or more electric circuits or loads (not shown) associated with the vehicle. For example, the battery unit 108 may be a source of electrical power for an electronic control unit, a sensor system associated with the vehicle, or an electric motor of the vehicle. In some embodiments, the battery unit 108 may correspond to a battery pack, which may have a plurality of clusters of batteries, surrounded by a suitable coolant and a charge controller (not shown in FIG. 1). Examples of the battery unit 108 may include, but are not limited to, a lead acid battery, a nickel cadmium battery, a nickel-metal hydride battery, a lithium-ion battery, and other rechargeable batteries.

The battery mounting structure may include the vehicle frame 102. The vehicle frame 102 may further include the lower mount structure 104 and the upper mount structure 106. The lower mount structure 104 may be coupled with the lower portion 102A of the vehicle frame 102. The upper mount structure 106 may be coupled with the upper portion 102B of the vehicle frame 102. By way of example, but not limitation, the lower portion 102A of the vehicle frame 102 may be in proximity of the ground surface and the upper portion 102B of the vehicle frame 102 may be away from the ground surface.

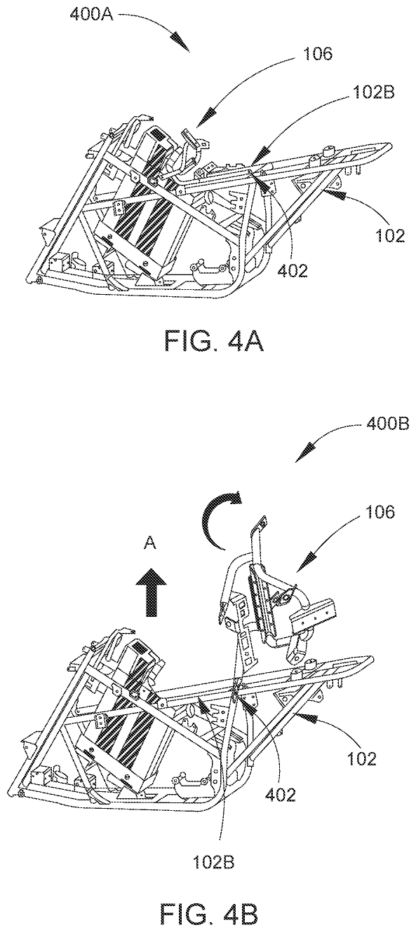

The lower mount structure 104 and the upper mount structure 106 may be attached to the vehicle frame 102, using at least one of a bolted joint, a welded joint, or a pivot joint. By way of example, and not limitation, the bolted joint may include a long bolt and a nut. The long bolt may be inserted into a pre-drilled hole provided on the vehicle frame 102, the lower mount structure 104, and the upper mount structure 106. Thereafter, the nut may be tightened onto bolt mating threads provided on the long bolt. The attachment of the lower mount structure 104 and the upper mount structure 106 with the vehicle frame 102 using the bolted joint may ease disassembly of at least one of the lower mount structure 104 or the upper mount structure 106 from the vehicle frame 102. The welded joint may join the at least one of the lower mount structure 104 or the upper mount structure 106 with the vehicle frame 102, using a suitable welding process. The attachment of the lower mount structure 104 and the upper mount structure 106 with the vehicle frame 102 using the welded joint may permanently joint at least one of the lower mount structure 104 or the upper mount structure 106 with the vehicle frame 102. The pivot joint may pivotally couple at least one of the lower mount structure 104 or the upper mount structure 106 with the vehicle frame 102. The attachment of the lower mount structure 104 and the upper mount structure 106 with the vehicle frame 102 using the pivot joint may ease disassembly of the at least one of the lower mount structure 104 or the upper mount structure 106 from the vehicle frame 102. Further details related to the pivot joint are provided, for example, in FIGS. 4A and 4B.

The lower mount structure 104 may receive the bottom portion of the battery unit 108 and the upper mount structure 106 may secure the top portion of the battery unit 108. The lower mount structure 104 may be coupled to the lower portion 102A of the vehicle frame 102 in an inclined position with respect to a horizontal plane, which may be configured to secure the battery unit 108 in the inclined position. By way of example, and not limitation, the inclined position of the battery unit 108 may include an inclination angle that may be between a range of about 35 degrees and 45 degrees. A space may be formed between the upper mount structure 106 and the lower mount structure 104. The space formed by the lower mount structure 104 and the upper mount structure 106 may be large enough to receive the battery unit 108 of a high capacity in the inclined position. The battery unit 108 with high capacity may power the vehicle for longer duration and may be effective for long routes or off-road driving.

FIG. 2A is a diagram that illustrates a lower mount structure associated with a battery mounting structure for a vehicle, in accordance with an embodiment of the disclosure. FIG. 2A is explained in conjunction with elements from FIG. 1. With reference to the FIG. 2A, there is shown a diagram 200A of the lower mount structure 104. The lower mount structure 104 may include a four-sided enclosure 202 having a base portion 202A and four sides 202B. The lower mount structure 104 may further include a plurality of rubber pads 204, and a plurality of pores 206.

The four-sided enclosure 202 may be configured to receive a bottom portion of the battery unit 108. The four-sided enclosure 202 may have a substantially rectangular shape or another shape (for example, a substantially square shape, a substantially circular shape, a substantially semi-circular shape, and the like).

The four-sided enclosure 202 may further include the base portion 202A and four sides 202B. The base portion 202A may be configured to receive the bottom portion of the battery unit 108. The base portion 202A may be configured to cover entire surface of the bottom portion and the four sides 202B may be configured to partially cover the battery unit 108. By way of example, and not limitation, the partial covering of the battery unit 108 by the four sides 202B may be preferred as it may help to reduce cost of manufacturing and weight of the lower mount structure 104.

The plurality of rubber pads 204 may be disposed on at least one of the base portion 202A or on the four sides 202B of the lower mount structure 104. The rubber pads 204 may include a steel base bonded to a rubber section. The steel base associated with the rubber pads 204 may be attached to one of the base portion 202A or on the four sides 202B of the lower mount structure 104. The rubber section may be in a direct contact with the bottom portion of the battery unit 108 and may be configured to absorb shock and jerk experienced by the lower mount structure 104 to protect the battery unit 108 from any physical damage. The shock or jerk experienced by the lower mount structure 104 may be due to a vibration in the vehicle frame 102, a sudden braking, uneven road conditions, or malfunctioning of vehicle components.

The base portion 202A of the lower mount structure 104 may include the plurality of pores 206. The plurality of pores 206 may be configured to allow liquid to drain out of the vehicle frame 102. By way of example, and not limitation, the lower mount structure 104 may collect liquid (for example, water) due to rain or off-road conditions. For instance, the lower mount structure 104 may collect fluid (for example, muddy water) due to operation of the vehicle on off-road tracks. Therefore, draining out of the liquid from the lower mount structure 104 from the plurality of pores 206 may prevent the vehicle frame 102 and the vehicle components from any water-related damage (such as a short circuit or rust).

FIG. 2B is a diagram that illustrates an upper mount structure associated with a battery mounting structure for a vehicle, in accordance with an embodiment of the disclosure. FIG. 2B is explained in conjunction with elements from FIG. 1 and FIG. 2A. With reference to the FIG. 2B, there is shown a diagram 200B of the upper mount structure 106. The upper mount structure 106 may include a battery fixing member 208 having a rubber padding 210. The upper mount structure 106 may further include a seat mount 212, a pair of brackets 214, and a plurality of slots 216.

The upper mount structure 106 may include the battery fixing member 208. The battery fixing member 208 may be configured to secure a top portion of the battery unit 108. The battery fixing member 208 may have a substantially tubular structure or another shape (for example, a substantially square shape, a substantially circular shape, a substantially semi-circular shape, and the like). The shape and dimensions of the battery fixing member 208 may correspond to that of the battery unit 108. The battery fixing member 208 may be made from high strength and shock absorbent materials (for example, a Polypropylene, a Polyurethane, a Polycarbonate, a Polyamideimide, and the like) to firmly secure the battery unit 108. In an embodiment, the battery fixing member 208 may be provided with a plurality of pre-drilled holes to secure the top portion of the battery unit 108 using suitable fasteners such as, a screw, or a nut and bolt.

The battery fixing member 208 may further include the rubber padding 210. The rubber padding 210 may include a metallic base bonded to a rubber section. The metallic base associated with the rubber padding 210 may be attached to the battery fixing member 208. The rubber section may be in a direct contact with the top portion of the battery unit 108 and may be configured to absorb shock and jerk experienced by the upper mount structure 106. The shock or jerk may be caused by at least one of a vibration in the vehicle frame 102, a sudden braking, uneven road conditions, or malfunctioning of vehicle components. The shock or jerk may be absorbed by the rubber section of the rubber padding 210 to protect the top portion of the battery unit 108 from any physical wear and tear.

The upper mount structure 106 may further include the seat mount 212. The seat mount 212 may be configured to mount a seat associated with the vehicle. In an example embodiment, the seat mount 212 may be a U-shaped transverse section. The inclined position of the battery unit 108 may have an inclination angle that may be based on a position of the seat mount 212. In case the position of the seat mount 212 is substantially parallel to a horizontal plane, the inclined position of the battery unit 108 may be substantially parallel to the horizontal plane. For example, if the position of the seat mount 212 is about 30 degrees with respect to the horizontal plane, then the inclined position of the battery unit 108 may be about 30 degrees with respect to the horizontal plane.

The upper mount structure 106 may further include at least a pair of brackets 214. The pair of brackets 214 may be configured to mount a tank cover associated with the vehicle. By way of example, and not limitation, the tank cover may be mounted using fasteners, such as a screw, or a nut and bolt. The pair of brackets 214 may have a substantially rectangular shape or may be formed with various other shapes (for example, a substantially square shape, a substantially rectangular shape, and the like).

The upper mount structure 106 may further include the plurality of slots 216 that may be configured to guide a plurality of electric wires that may connect the battery unit 108 to one or more functional components associated with the vehicle. The plurality of slots 216 may have a substantially rectangular shape or may be formed to have various other shapes (for example, a substantially square shape, a substantially rectangular shape, and the like). The choice of the shape for each slot may be based on a shape of the upper mount structure 106 or other vehicle design requirements.

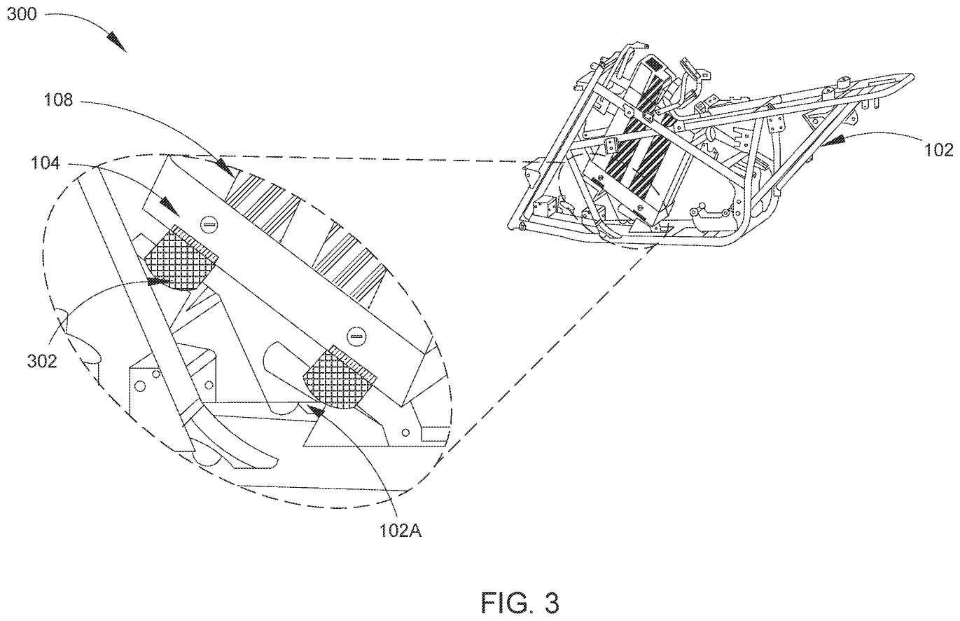

FIG. 3 is a diagram that illustrates a shock absorber associated with a battery mounting structure for a vehicle, in accordance with an embodiment of the disclosure. FIG. 3 is explained in conjunction with elements from FIG. 1, FIG. 2A, and FIG. 2B. With reference to FIG. 3 there is shown an exemplary scenario 300 that includes a shock absorber 302 that may be mounted between the lower portion 102A of the vehicle frame 102 and the base portion 202A of the lower mount structure 104.

The shock absorber 302 may be configured to absorb shock and jerk experienced by the lower portion 102A of the vehicle frame 102. Examples of the shock absorber 302 may include, but are not limited to, a spiral spring, a leaf spring, or a coil spring. In certain situations, the lower portion 102A of the vehicle frame 102 may be experience shocks and jerk, which may compress or rebound a spring associated with the shock absorber 302. The shocks and jerk experienced by the lower portion 102A of the vehicle frame 102 may be due to a vibration in the vehicle frame 102, a sudden braking, a road condition, or a malfunctioning of vehicle components.

In an exemplary embodiment, the shock absorber 302 may include an air suspension, which may include alteration of stiffness of a spring by adjusting an effective volume of the spring associated with the shock absorber 302. The adjustment of the effective volume of the spring may be achieved via a solenoid valve to connect the spring to an extra volume (for example, an accumulator). Further, the extra volumes may allow a spring rate to be altered based on the shock and jerk, which may be subjected due to at least one of a vibration in the vehicle frame 102, a sudden braking, a road condition, or a malfunctioning of vehicle components. To stiffen the spring while the vehicle is cruising at a higher speed on longer routes or over off-road tracks, the solenoid may disconnect the extra volume. In case a softer spring rate is required based on the shock and jerk, the solenoid may connect the extra volume. The shock absorber 302 may absorb the shock and jerk experienced by the lower portion 102A of the vehicle frame 102 and may limit transmission of the shock and jerk to the base portion 202A of the lower mount structure 104. Therefore, the base portion 202A of the lower mount structure 104 may be protected from physical damages. It should be noted that the exemplary scenario 300 of FIG. 3, is for exemplary purposes and should not be construed to limit the scope of the disclosure.

FIGS. 4A and 4B are scenario diagrams that collectively illustrate configuration of an upper mount structure in a stowed and an un-stowed configuration to control access to a battery unit associated with a vehicle, in accordance with an embodiment of the disclosure. FIGS. 4A and 4B are explained in conjunction with elements from FIG. 1, FIG. 2A, FIG. 2B, and FIG. 3. With reference to FIG. 4A, there is shown a scenario diagram 400A that includes a stowed configuration that may include a pivot point 402. With reference to FIG. 4B, there is shown another scenario diagram 400B that includes an un un-stowed configuration that may include the pivot point 402.

The upper mount structure 106 may be pivotally coupled to the upper portion 102B of the vehicle frame 102 using the pivot point 402. The pivot point 402 may be configured to provide a rotational movement to the upper mount structure 106 about an axis, which may be substantially parallel to a lateral axis of the upper mount structure 106. The pivot point 402 may allow a rotational movement of the upper mount structure 106 about a single point, and therefore may have one degree of freedom. The rotational movement about the pivot point 402 may be required to control access to the battery unit 108. In an embodiment, the movement of the pivot point 402 may be automatically controlled via an electronic control unit (ECU) associated with the vehicle. In another embodiment, the movement of the pivot point 402 may be manually controlled by the user by application of resistive force to provide required rotational movement to the pivot point 402 to place the upper mount structure 106 in the stowed or the un-stowed configuration.

In FIG. 4A, the stowed configuration of the upper mount structure 106 along the upper portion 102B of the vehicle frame 102 is shown. The stowed configuration of the upper mount structure 106 may help to secure the battery unit 108 in the space formed between the upper mount structure 106 and the lower mount structure 104.

In FIG. 4B, the un-stowed configuration of the upper mount structure 106 from the upper portion 102B of the vehicle frame 102 is shown. The pivot point 402 may be configured to move the upper mount structure 106 in the un-stowed configuration. The upper mount structure 106 may be coupled with the seat associated with the vehicle. A movement of the seat coupled to the upper mount structure 106 may cause the upper mount structure 106 to move, leaving a gap in the vehicle frame 102 to slidably remove the battery unit 108 from the space formed between the upper mount structure 106 and the lower mount structure 104. The un-stowed configuration of the upper mount structure 106 may allow the user to access the battery unit 108. By way of example, and not limitation, if the user requires to replace or repair the battery unit 108, then the user may move the seat coupled to the upper mount structure 106 along the direction of rotation (for example, a clockwise direction). The pivot point 402 may be configured to move the upper portion 102B along the direction of rotation with respect to a vertical plane. Further, in the un-stowed configuration, the battery unit 108 may be slidably removed by the user in a direction “A” as shown in FIG. 4B. After the battery unit 108 is repaired or replaced, the user may move the seat coupled to the upper mount structure 106 along a direction opposite to the direction of rotation (for example, a counterclockwise direction) to place the upper mount structure 106 in the stowed configuration.

It should be noted that the scenario diagrams 400A and 400B of FIGS. 4A and 4B are for exemplary purposes and should not be construed to limit the scope of the disclosure.

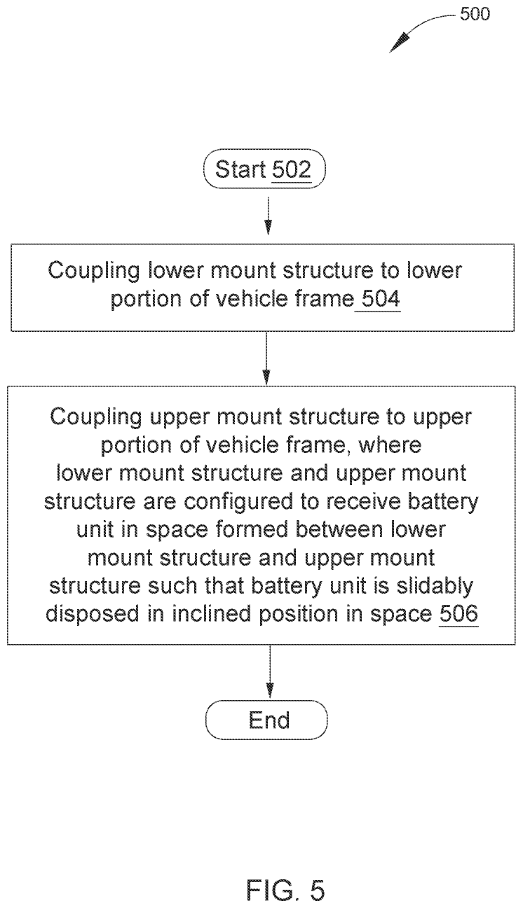

FIG. 5 is a flowchart that illustrates an exemplary method of assembling a vehicle frame for a vehicle, in accordance with an embodiment of the disclosure. FIG. 5 is explained in conjunction with elements from FIG. 1, FIG. 2A, FIG. 2B, FIG. 3, FIG. 4A and FIG. 4B. With reference to FIG. 6, there is shown a flowchart 500, which may depict method of assembling the vehicle frame 102 for the vehicle. The method illustrated in the flowchart 500 may start at 502 and proceed to 504.

At 504, the lower mount structure 104 may be coupled to the lower portion 102A of the vehicle frame 102. In one or more embodiments, the lower mount structure 104 may be coupled to the lower portion 102A using at least one of a bolted joint, a welded joint, or a pivot joint, as further described, in detail, for example, in FIG. 1.

At 506, the upper mount structure 106 may be coupled to the upper portion 102B of the vehicle frame 102. In one or more embodiments, the upper mount structure 106 may be coupled to the upper portion 102B using at least one of a bolted joint, a welded joint, or a pivot joint, as further described, in detail, for example, in FIG. 1. Further, the lower mount structure 104 and the upper mount structure 106 may be configured to receive the battery unit 108 in the space formed between the lower mount structure 104 and the upper mount structure 106 such that the battery unit 108 may be slidably disposed in the inclined position in the space, as further described, in detail, for example, in FIG. 1, FIG. 2A, FIG. 2B, FIG. 3, FIG. 4A and FIG. 4B. Control may pass to end.

Although the flowchart 500 is illustrated as discrete operations, such as 502, and 504, the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe, and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A vehicle frame for a vehicle, comprising:
a lower mount structure coupled to a lower portion of the vehicle frame; and
an upper mount structure coupled to an upper portion of the vehicle frame,
wherein the lower mount structure and the upper mount structure are configured to receive a battery unit in a space formed between the lower mount structure and the upper mount structure such that the battery unit is slidably disposed in an inclined position in the space.

2. The vehicle frame according to claim 1, wherein the lower mount structure is having a four-sided enclosure and the upper mount structure is having a battery fixing member,
wherein the four-sided enclosure is configured to receive a bottom portion of the battery unit and the battery fixing member is configured to secure a top portion of the battery unit.

3. The vehicle frame according to claim 2, wherein the battery fixing member associated with the upper mount structure comprises a rubber padding to absorb shock and jerk experienced by the upper mount structure.

4. The vehicle frame according to claim 1, wherein the lower mount structure comprises a plurality of rubber pads.

5. The vehicle frame according to claim 4, wherein the plurality of rubber pads is disposed on at least one of: a base portion or on four sides of the lower mount structure.

6. The vehicle frame according to claim 1, wherein the inclined position of the battery unit includes an inclination angle that is between a range of about 35 degrees and 45 degrees with respect to a horizontal plane.

7. The vehicle frame according to claim 1, wherein the lower mount structure and the upper mount structure are attached to the vehicle frame using at least one of a bolted joint, a welded joint, or a pivot joint.

8. The vehicle frame according to claim 1, wherein the upper mount structure comprises a seat mount configured to mount a seat associated with the vehicle.

9. The vehicle frame according to claim 8, wherein the seat mount is a U-shaped transverse section.

10. The vehicle frame according to claim 8, wherein the inclined position of the battery unit includes an inclination angle that is based on a position of the seat mount.

11. The vehicle frame according to claim 1, wherein the upper mount structure comprises at least a pair of brackets configured to mount a tank cover associated with the vehicle.

12. The vehicle frame according to claim 1, wherein the upper mount structure comprises a plurality of slots configured to guide a plurality of electric wires that connect the battery unit to one or more functional components associated with the vehicle.

13. The vehicle frame according to claim 1, wherein the lower mount structure comprises a shock absorber mounted between the lower portion of the vehicle frame and a base portion of the lower mount structure.

14. The vehicle frame according to claim 1, wherein the lower mount structure comprises a plurality of pores on a base portion of the lower mount structure, and wherein the plurality of pores is configured to allow liquid to drain out of the vehicle frame.

15. The vehicle frame according to claim 1, wherein the upper mount structure is pivotally coupled to the upper portion of the vehicle frame, and wherein a movement of a seat coupled to the upper mount structure causes the upper mount structure to move, leaving a gap in the vehicle frame to slidably remove the battery unit from the space.

16. A battery mounting structure for a vehicle, comprising:
a lower mount structure coupled to a lower portion of a vehicle frame; and
an upper mount structure coupled to an upper portion of the vehicle frame,
wherein the lower mount structure and the upper mount structure are configured to receive a battery unit in a space formed between the lower mount structure and the upper mount structure such that the battery unit is slidably disposed in an inclined position in the space.

17. The battery mounting structure according to claim 16, wherein the lower mount structure is having a four-sided enclosure and the upper mount structure is having a battery fixing member,
wherein the four-sided enclosure is configured to receive a bottom portion of the battery unit and the battery fixing member is configured to secure a top portion of the battery unit.

18. The battery mounting structure according to claim 16, wherein the upper mount structure is having a battery fixing member that comprises a rubber padding to absorb shock and jerk experienced by the upper mount structure.

19. The battery mounting structure according to claim 16, wherein the lower mount structure comprises a plurality of rubber pads.

20. A method of assembling a battery mounting structure, comprising:
coupling a lower mount structure to a lower portion of a vehicle frame; and
coupling an upper mount structure to an upper portion of the vehicle frame,
wherein the lower mount structure and the upper mount structure are configured to receive a battery unit in a space formed between the lower mount structure and the upper mount structure such that the battery unit is slidably disposed in an inclined position in the space.
